(19) United States
(12) Patent Application Publication
(10) Pub. No.: US 2008/0063500 A1
(43) Pub. Date: Mar. 13, 2008

(54) BREAK AWAY MECHANISM FOR A LIFTGATE PARTING BAR

(76) Inventor: Mikko Niinisto, Salo (FI)

Correspondence Address: BROUSE MCDOWELL LPA, 388 SOUTH MAIN STREET, SUITE 500, AKRON, OH, 44311, US

(21) Appl. No.: 11/851,608

(22) Filed: Sep. 7, 2007

Related U.S. Application Data
(60) Provisional application No. 60/824,974, filed on Sep. 8, 2006.

(51) Int. Cl. B60P 1/44; B60P 1/26; G05G 5/06

(52) U.S. Cl. 414/557; 29/428; 74/527

(57) ABSTRACT

A liftgate assembly may include: a frame structure including (a) a mount assembly to mount the liftgate assembly to a vehicle and, (b) a linkage assembly connected to the mount assembly; a platform connected to the linkage assembly; a lift assembly for use in moving the platform between a folded position and an unfolded position; a parting bar used to contact the platform for assistance in folding or unfolding the platform; and, a break away mechanism connected between the parting bar and the frame structure. The break away mechanism permits the parting bar to break away from the frame structure without substantially damaging the parting bar.

This application claims priority from U.S. Ser. No. 60/824,974, entitled BREAK AWAY MECHANISM FOR A LIFTGATE PARTING BAR, filed Sep. 8, 2006, which is incorporated herein by reference.

### I. BACKGROUND OF THE INVENTION

A. Field of Invention

This invention pertains to the art of methods and apparatuses regarding liftgates and more specifically to methods and apparatuses regarding the protection of a parting bar used in folding a liftgate platform into and out of a storage condition.

B. Description of the Related Art

It is well known in the art to attach liftgates to vehicle trailers or other forms of vehicle cargo holds to assist with loading and unloading of the vehicles. In general, liftgates include a platform or deck and some motorized system, often including a hydraulic system, used to move the platform. To load cargo from a ground surface to the vehicle bed, the platform is positioned in a lowered position where it is generally parallel with the ground surface. The cargo can then be easily placed onto the platform. The platform is then lifted to a raised position generally parallel with the vehicle bed. The cargo can then be easily loaded into the vehicle. To unload cargo from the vehicle, the reverse steps are taken.

Various types and styles of liftgates are known in the art. Some liftgates, sometimes referred to as flip-a-way or fold-up liftgates, are foldable or collapsible into a stowed or storage condition. When it is desirable to use the liftgate, it can be unfolded out of the storage condition. Most fold-up liftgate assemblies include: (1) a mount frame used to install the liftgate assembly beneath the bed of a truck or trailer; (2) a parallel arm linkage supported to the mount frame; (3) a deck or platform carried by the arm linkage; (4) a hydraulic actuator operating between the mount frame and the parallel arm linkage for lifting the linkage and the deck; and, (5) a control assembly for operating the liftgate assembly.

It is also well known in the art to provide fold-up liftgates with another device that assists in folding and/or unfolding of the platform. This device is referred to with various names including “automatic kickout,” “release mechanism,” “unfolder,” “opener arm,” and “parting bar.” This device, termed parting bar in this patent, typically has one end that is connected to the mount frame or arm linkage and another end that selectively contacts the platform. Often the end that contacts the platform has a contact surface used to minimize friction between the parting bar and the platform. The specific purpose for contacting the platform with the parting bar varies but generally it holds the platform in a desired position during the folding and unfolding of the platform. The parting bar may, for example, keep the platform at an ideal position for easy access by the user when unfolding the platform. As another example, the parting bar may be used in lowering the platform into the folded condition.

While parting bars generally work well for their intended purpose, one known disadvantage is that they are relatively out in the open and thus subject to damage from undesirable forces. Once damaged, the parting bar must be replaced. This damage causes down time for the liftgate while the parting bar is replaced and unwanted expense to replace the parting bar.

The present invention provides methods and apparatuses for minimizing the damage caused by undesirable forces on a parting bar. This invention thus overcomes the foregoing difficulties and others while providing better and more advantageous overall results.

### II. SUMMARY OF THE INVENTION

According to one embodiment of this invention, a liftgate assembly may include: a frame structure including (a) a mount assembly to mount the liftgate assembly to a vehicle and, (b) a linkage assembly connected to the mount assembly; a platform connected to the linkage assembly; a lift assembly for use in moving the platform between a folded position and an unfolded position; a parting bar used to contact the platform for assistance in folding or unfolding the platform; and, a break away mechanism connected between the parting bar and the frame structure. The break away mechanism permits the parting bar to break away from the frame structure without substantially damaging the parting bar.

According to another embodiment of this invention, the break away mechanism may include a fuse member designed to become substantially damaged by a force exerted on the parting bar prior to the parting bar becoming substantially damaged by the force.

According to another embodiment of this invention, a method may comprise the steps of: I. providing a liftgate assembly comprising: (1) a frame structure comprising: (a) a mount assembly used to mount the liftgate assembly to a vehicle; and, (b) a linkage assembly operatively connected to the mount assembly; (2) a platform operatively connected to the linkage assembly; (3) a lift assembly for use in moving the platform between a folded position and an unfolded position; and, (4) a parting bar operatively attached to the frame structure for use in contacting the platform for assistance in folding or unfolding the platform; II. applying a force to the parting bar; and III. breaking away the parting bar from the frame structure without substantially damaging the parting bar.

One advantage of this invention is that the parting bar can break away when struck by an undesirable force thereby minimizing damage to the parting bar.

Another advantage of this invention is that the parting bar assembly can be easily repaired after being struck by an undesirable force. This reduces liftgate downtime.

Another advantage of this invention is that the parting bar assembly can be repaired with minimal expense.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a perspective side view of a liftgate mounted to a vehicle with the liftgate platform shown in the lowered position.

FIG. 2 is a perspective close up view, partially disassembled, of the liftgate displayed in FIG. 1 showing one embodiment of a parting bar.

FIG. 3 is a side view of the liftgate displayed in FIG. 1 but showing the liftgate in a folded position.

FIG. 4 is a perspective view of another embodiment parting bar having a break away mechanism according to one embodiment of this invention.

FIG. 5 is an exploded view of the parting bar and break away mechanism shown in FIG. 4.

### IV. DETAILED DESCRIPTION OF THE INVENTION

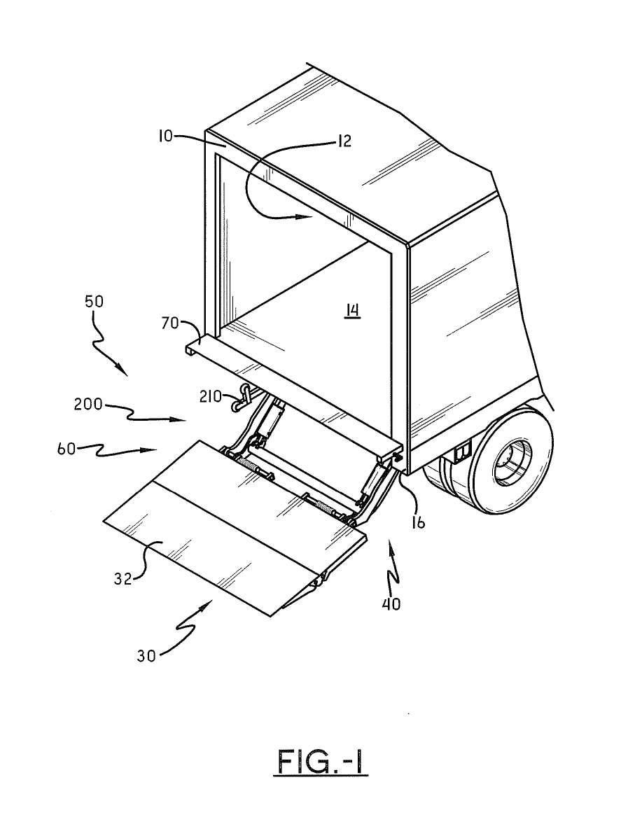

Referring now to the drawings wherein the showings are for purposes of illustrating embodiments of the invention only and not for purposes of limiting the same, FIG. 1 shows a liftgate assembly 50 including a break away mechanism 200 according to this invention. While the liftgate assembly 50 shown is the style known as flip-a-way or fold-up, it is to be noted that this invention may be used with any liftgate style, type and size, when applied with sound engineering judgment. The liftgate assembly 50 may be mounted to a vehicle 10 having a cargo hold 12 with a vehicle bed 14. The vehicle 10 may also have a sill 16 at the outer edge of the cargo hold 12 and conventional vehicle frame members (not shown) to which the liftgate assembly 50 may be attached to the vehicle 10 in any conventional manner. Any type and style of vehicle will work well with this invention when applied with sound engineering judgment.

With reference now to FIGS. 1-3, the liftgate assembly 50 may include a frame structure 60, a platform assembly 30 including a platform or deck 32, a lift assembly 40 and a bed extension 70. The frame structure 60 may include a mount assembly 62 and a linkage assembly 64. The mount assembly 62 may include one or more mounting tubes 20 and one or more mounting plates 22 as well as other components shown but not referenced. The mount assembly 62 is used to mount the liftgate assembly 50 to the vehicle frame in any convention manner and thus will not be described in detail. The linkage assembly 64 supports the platform 32 during its use, its movement, and when in its storage position. The linkage assembly 64 may include one or two pair of lift arms 54, 54. Preferably, the lift arms 54, 54 remain parallel with each other throughout all the motions of the linkage assembly 64. Each lift arm 54 may be operatively attached at a first end to a mounting tube 20 and operatively attached at a second end to the platform 32.

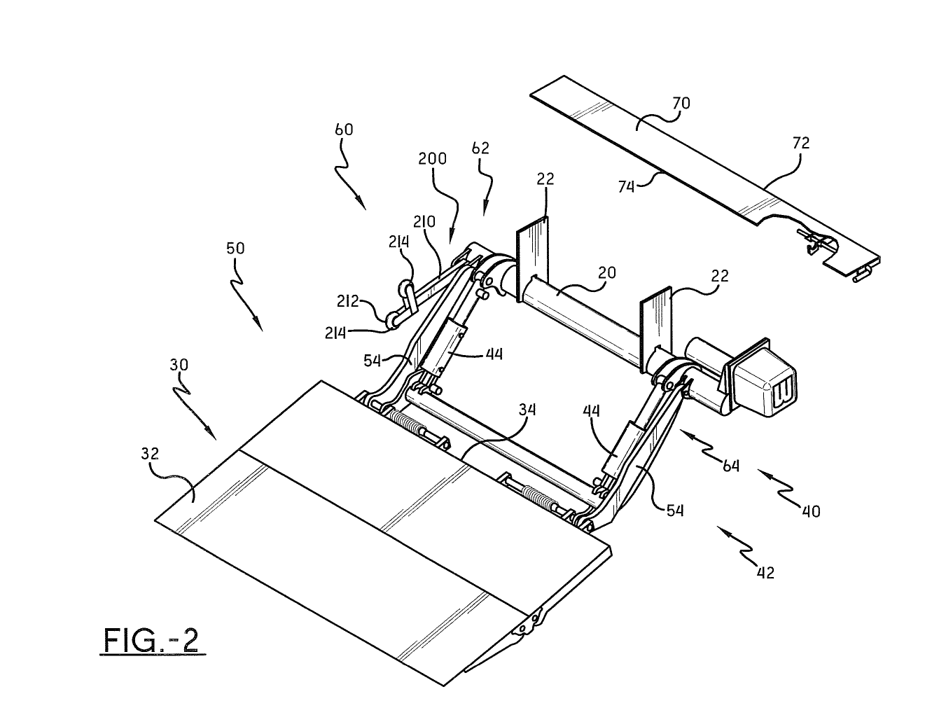

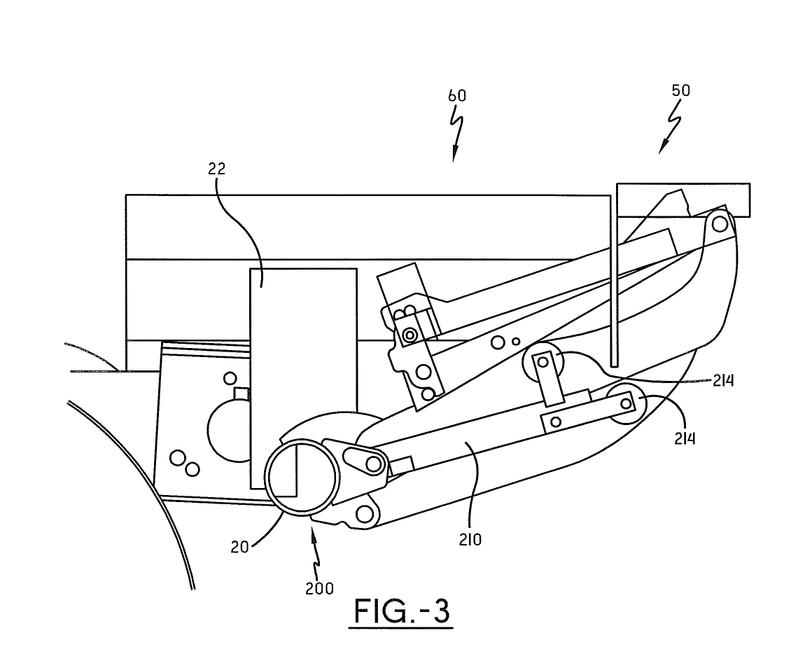

With continuing reference to FIGS. 1-3, the lift assembly 40 is used to move the platform 32 between a folded, storage, or closed position (shown in FIG. 3), a lowered position (shown in FIGS. 1 and 2) and a raised position (not shown). The lift assembly 40 may include a control system (not shown) and a hydraulic system 42 used to operate one or more cylinders 44 to move the platform 32. The basic operation of the control and hydraulic systems are well known and will not be described in detail. The bed extension 70 may have a first side 72 that may abut the vehicle 10, such as along the sill 16, and a second side 74 that may abut a first end 34 of the platform 32.

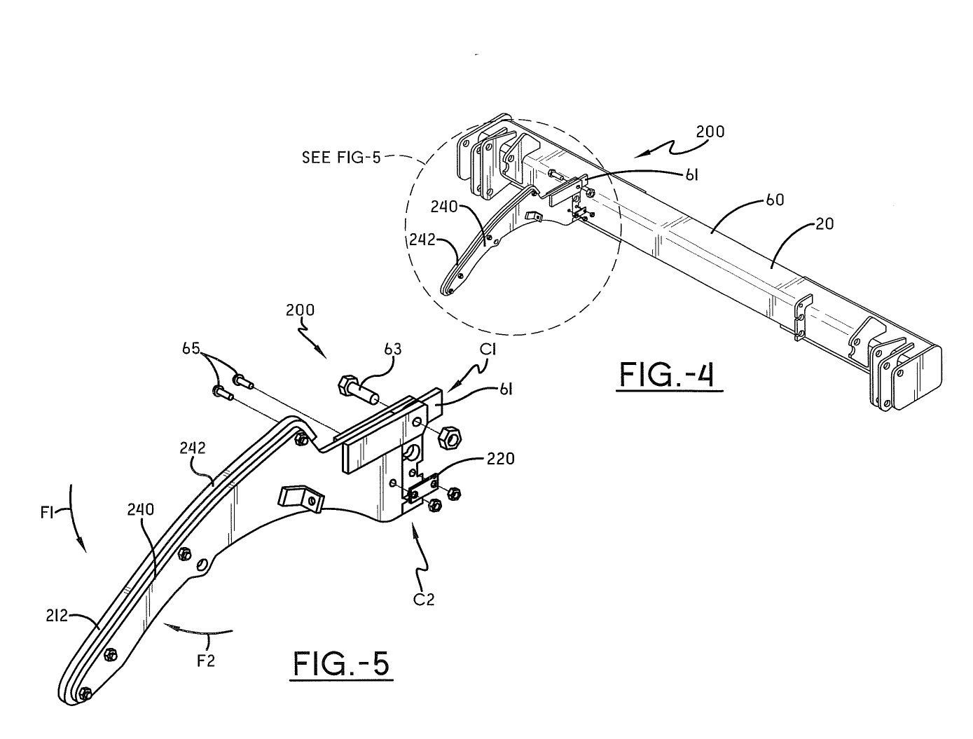

Still referring to FIGS. 1-3, the liftgate assembly 50 may include a parting bar 210 having one or more contact surfaces 212 that may contact the platform 32 for assistance in folding or unfolding the platform 32. Each contact surface 212 may minimize the friction between the parting bar 210 and the platform 32 as they come into direct contact and, typically, move relative to each other. It should be noted that the break away mechanism 200 of this invention will work equally well with parting bars having any type and any number, including zero, of contact surfaces. For the embodiment shown in FIGS. 1-3, the parting bar 210 uses a pair of rollers 214, 214 each defining a contact surface 212. However, other types of contact surfaces such as slide bearings (shown in FIGS. 4-5) or other slide surfaces are also contemplated. It should be noted that the purpose and particular use of the parting bar 210 varies but is well known and will not be described in detail.

With reference now to FIGS. 1-5, the liftgate assembly 50 of this invention may also include a break away mechanism 200 permitting the parting bar 210 to break away from the frame structure 60 without substantially damaging the parting bar 210. By “break away” it is meant that the connection of the parting bar 210 to the frame structure 60 is at least partially reduced, weakened, or separated. As a result, if the parting bar 210 is struck by an undesirable force that would otherwise damage the parting bar 210, the break away mechanism 200 permits the parting bar 210 to at least partially separate from the frame structure 60 to minimize damage to the parting bar 210. For the embodiments shown, the break away mechanism 200 is connected between the parting bar 210 and the mounting tube 20. This invention works equally well, however, when the break away mechanism 200 is connected between the parting bar 210 and any portion of the frame structure 60, including but not limited to any portion of the linkage assembly 64.

With reference now to FIGS. 4-5, another embodiment parting bar 240 is shown. The parting bar 240 differs from the parting bar 210 shown in FIGS. 1-3 primarily in that in place of rollers used with parting bar 210, the parting bar 240 has a slide bearing 242 defining the contact surface 212. However, the remaining discussion concerning how the parting bar connects to the frame structure and the break away mechanism may be similar for both embodiments. The parting bar 240 has two connection sites C1, C2 to the frame structure 60. More specifically, the parting bar 240 shown is connected to a frame bracket 61, which extends from the mounting tube 20, with a pivotal connection at the first connection site C1 and with the break away mechanism 200 at the second connection site C2. The pivotal connection C1 may be established with a pivot bolt 63 received through openings in the parting bar 240 and the frame bracket 61, as shown. The break away mechanism 200 may include a fuse member 220 that is attached at one end to the parting bar 240 and at the other end to the frame bracket 61. The method of connecting the fuse member 200 can be any chosen with sound engineering judgment but is with a pair of connection bolts 65, 65 in the embodiment shown. The fuse member 220 is designed to become substantially damaged by a force exerted on the parting bar 240 prior to the parting bar 240 becoming substantially damaged by the force. Thus, for example, if a substantial force in direction F1 is applied to the parting bar 240, the fuse member 220 will buckle (and if the force is sufficient, break apart) under the compressive load. As the fuse member 220 buckles, the parting bar 240 will pivot in direction F1 about the pivot bolt 63. For another example, if a substantial force in direction F2 is applied to the parting bar 240, the fuse member 220 will stretch (and if the force is sufficient, break apart) under the tensile load. As the fuse member 220 stretches, the parting bar 240 will pivot in direction F2 about the pivot bolt 63.

With continuing reference to FIGS. 4-5, the fuse member 220 can be made of any material or composite of materials chosen with sound engineering judgment that fails or sustains substantial damage prior to the parting bar as described above. In one embodiment, the fuse member 220 may be formed of steel. In another embodiment, the fuse member 220 may be formed of plastic. In yet another embodiment, the fuse member 220 may be formed of an alloy such as aluminum.

With reference now to FIGS. 1-5, with the use of the break away mechanism 200 of this invention, it is easy to repair the parting bar 210, 240 should it be struck by a substantial undesirable force. If this occurs, the fuse member 220 will become damaged, as described above, protecting the parting bar 210, 240 from substantial damage. To then repair the parting bar 210, 240, it is only necessary to replace the damaged fuse member with a new fuse member. This greatly reduces liftgate downtime (it is much easier to replace a fuse member 220 than a parting bar 210, 240) and makes parting bar repair much less expensive (the cost of a new fuse member 220 is much less than the cost of a new parting bar 210, 240).

Multiple embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

I/we claim:

1. A liftgate assembly comprising:
a frame structure comprising:
(a) a mount assembly that may be used to mount the liftgate assembly to a vehicle;
(b) a linkage assembly operatively connected to the mount assembly;
a platform operatively connected to the linkage assembly;
a lift assembly for use in moving the platform between a folded position and an unfolded position;
a parting bar that may be used to contact the platform for assistance in folding or unfolding the platform; and,
a break away mechanism operatively connected between the parting bar and the frame structure, the break away mechanism permitting the parting bar to break away from the frame structure without substantially damaging the parting bar.

2. The liftgate assembly of claim 1 wherein the break away mechanism comprises:
a fuse member that may be used to become substantially damaged by a force exerted on the parting bar prior to the parting bar becoming substantially damaged by the force.

3. The liftgate assembly of claim 1 wherein the parting bar has at least first and second connection sites to the frame structure and the second connection site comprises the break away mechanism.

4. The liftgate assembly of claim 3 wherein the first connection site comprises a pivotal connection.

5. The liftgate assembly of claim 4 wherein the break away mechanism comprises:
a fuse member that may be used to become substantially damaged by a force exerted on the parting bar prior to the parting bar becoming substantially damaged by the force.

6. A method comprising the steps of:
providing a liftgate assembly comprising: (1) a frame structure comprising: (a) a mount assembly used to mount the liftgate assembly to a vehicle; and, (b) a linkage assembly operatively connected to the mount assembly; (2) a platform operatively connected to the linkage assembly; (3) a lift assembly for use in moving the platform between a folded position and an unfolded position; and, (4) a parting bar operatively attached to the frame structure for use in contacting the platform for assistance in folding or unfolding the platform;
applying a force to the parting bar; and
breaking away the parting bar from the frame structure without substantially damaging the parting bar.

7. The method of claim 6 wherein the step of, breaking away the parting bar from the frame structure without substantially damaging the parting bar, comprises the step of:
substantially damaging a first fuse member that operatively connected the parting bar to the frame structure.

8. The method of claim 7 wherein the step of, substantially damaging a first fuse member that operatively connected the parting bar to the frame structure, comprises the step of:
buckling the first fuse member.

9. The method of claim 8 wherein the step of, substantially damaging a first fuse member that operatively connected the parting bar to the frame structure, further comprises the step of:
breaking apart the first fuse member.

10. The method of claim 7 wherein the step of, substantially damaging a first fuse member that operatively connected the parting bar to the frame structure, comprises the step of:
stretching the first fuse member.

11. The method of claim 10 wherein the step of, substantially damaging a first fuse member that operatively connected the parting bar to the frame structure, further comprises the step of:
breaking apart the first fuse member.

12. The method of claim 7 further comprising the steps of:
replacing the first fuse member with a second fuse member; and,
reattaching the parting bar to the frame structure.

13. The method of claim 6 wherein the step of, breaking away the parting bar from the frame structure without substantially damaging the parting bar, comprises the step of:
pivoting the parting bar with respect to the frame structure.

14. A method comprising the steps of:
providing a liftgate assembly comprising: (1) a frame structure comprising: (a) a mount assembly used to mount the liftgate assembly to a vehicle; and, (b) a linkage assembly operatively connected to the mount assembly; (2) a platform operatively connected to the linkage assembly; (3) a lift assembly for use in moving the platform between a folded position and an unfolded position; and, (4) a parting bar for use in contacting the platform for assistance in folding or unfolding the platform, the parting bar having first and second connection sites to the frame structure;
applying a force to the parting bar;
breaking away the parting bar from the frame structure at the second connection site; and,
pivoting the parting bar with respect to the frame structure at the first connection site.

15. The method of claim 14 wherein the step of, breaking away the parting bar from the frame structure at the second connection site, comprises the step of:
substantially damaging a first fuse member that operatively connected the parting bar to the frame structure.

16. The method of claim 15 wherein the step of, substantially damaging a first fuse member that operatively connected the parting bar to the frame structure, comprises the step of:
buckling the first fuse member.

17. The method of claim 16 wherein the step of, substantially damaging a first fuse member that operatively connected the parting bar to the frame structure, further comprises the step of:
breaking apart the first fuse member.

18. The method of claim 15 wherein the step of, substantially damaging a first fuse member that operatively connected the parting bar to the frame structure, comprises the step of:
stretching the first fuse member.

19. The method of claim 18 wherein the step of, substantially damaging a first fuse member that operatively connected the parting bar to the frame structure, further comprises the step of:
breaking apart the first fuse member.

20. The method of claim 15 further comprising the steps of:
replacing the first fuse member with a second fuse member; and,
reattaching the parting bar to the frame structure.
